(19) United States
(12) Patent Application Publication
(10) Pub. No.: US 2025/0285313 A1
(43) Pub. Date: Sep. 11, 2025

(54) Method For Predicting Volume Of Object Based On Data Before And After Changes To The Object

(71) Applicant: NUVILABS Co., Ltd., Incheon (KR)

(72) Inventor: Eunseong CHA, Seoul (KR)

(73) Assignee: NUVILABS Co., Ltd., Incheon (KR)

(21) Appl. No.: 19/069,694

(22) Filed: Mar. 4, 2025

(30) Foreign Application Priority Data
Mar. 8, 2024 (KR) 10-2024-0033112

(51) Int. Cl. G06T 7/62; G06T 7/254; G06T 7/564

(52) U.S. Cl. CPC G06T 7/62; G06T 7/254; G06T 7/564; G06T 2207/10028

(57) ABSTRACT

Disclosed is a method for predicting a volume of an object, the method performed by one or more processors of a computing device according to an exemplary embodiment of the present disclosure.

The method may include: obtaining a first-time image and a second-time image including a container capable of containing an object; identifying a second object area for the second-time image and identifying a first object area for the first-time image; obtaining first multi-dimensional data based on the first object area included in the first-time image and obtaining second multi-dimensional data based on the second object area included in the second-time image; and predicting a volume of the object based on the first multi-dimensional data and the second multi-dimensional data.

### CROSS-REFERENCE TO RELATED APPLICATIONS

This application claims priority to and the benefit of Korean Patent Application No. 10-2024-0033112 filed in the Korean Intellectual Property Office on Mar. 8, 2024, the entire contents of which are incorporated herein by reference.

### TECHNICAL FIELD

The present disclosure relates to a method for predicting a volume of an object, and more particularly, to a method for obtaining data before and after a change of an object by using multi-dimensional data of a container containing an object, and predicting a volume of the object based on the obtained data.

### BACKGROUND ART

In related art, in order to calculate the amount of food waste, various methods such as video analysis and photographic measurement, measurement using a metering device, and a measurement method using geometric modeling were used. However, in the case of the video analysis and the photographic measurement, there is a problem that requires appropriate angle and lighting for accurate volume measurement, and the accuracy can be reduced due to texture or color fluctuations. In addition, in the case of the method using the metering device, it was difficult to estimate a volume of food with variable density only with weight. Therefore, in recent years, a scheme has been used, which takes photos of food contained in the container with a deep camera to predict the volume of a load amount of the food waste. However, even though data before and after a volume food waste is changed secured by accurately identifying a reference time before and after the volume of the food waste which is changed in real time is changed, there is a problem in that it is difficult to calculate an accurate volume of the object through the secured data. Therefore, there is a need for a method in which the reference time before and after the volume of the object changed is identified by utilizing the multi-dimensional data of the container containing the object to obtain data before and after the change of the object, and estimate whether the object contained in the container changes, and predict an accurate volume of the object based on the obtained data.

On the other hand, the present disclosure has been derived at least based on the technical background described above, but the technical problem or object of the present disclosure is not limited to solving the problems or disadvantages described above. That is, the present disclosure may cover various technical issues related to the content to be described below, in addition to the technical issues discussed above.

### SUMMARY OF THE INVENTION

The present disclosure has been made in an effort to provide a method for predicting a volume of an object, and more particularly, to obtaining data before and after changes of an object by using multi-dimensional data of a container containing an object, and predicting a volume of the object based on the obtained data.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method performed by a computing device. The method may include: obtaining a first-time image and a second-time image including a container capable of containing an object; identifying a second object area for the second-time image and identifying a first object area for the first-time image; obtaining first multi-dimensional data based on the first object area included in the first-time image and obtaining second multi-dimensional data based on the second object area included in the second-time image; and predicting a volume of the object based on the first multi-dimensional data and the second multi-dimensional data.

Alternatively, the identifying of the second object area for the second-time image and identifying the first object area for the first-time image may include identifying a second container area included in the second-time image and identifying a second object area inside the second container area; and identifying a first container area included in the first-time image, which corresponds to the second container area, and identifying a first object area inside the first container area.

Alternatively, the identifying of the second object area for the second-time image and identifying the first object area for the first-time image may include identifying the first object area for the first-time image based on the second object area.

Alternatively, the multi-dimensional data may include multi-dimensional mesh data.

Alternatively, the filtering of the multi-dimensional data based on the identified area may include filtering the multi-dimensional data based on depth data of the identified area.

Alternatively, the obtaining of the first multi-dimensional data based on the first object area included in the first-time image and obtaining the second multi-dimensional data based on the second object area included in the second-time image may include obtaining first point cloud data based on the first object area, and obtaining second point cloud data based on the second object area; and obtaining the first multi-dimensional data based on the obtained first point cloud data and obtaining the second multi-dimensional data based on the second point cloud data.

Alternatively, the obtaining of the first multi-dimensional data based on the obtained first point cloud data and obtaining the second multi-dimensional data based on the second point cloud data may include obtaining the first multi-dimensional data and the second multi-dimensional data by correcting each of empty spaces included in the first point cloud data and the second point cloud data, respectively.

Alternatively, a process of correcting each of the empty spaces included in the first point cloud data and the second point cloud data may be performed based on at least one of an interpolation method; a reconstruction method; or a filtering method.

Alternatively, the predicting of the volume of the object based on the first multi-dimensional data and the second multi-dimensional data may include obtaining integrated multi-dimensional data based on the first multi-dimensional data and the second multi-dimensional data; and predicting the volume of the object based on the integrated multi-dimensional data.

Alternatively, the obtaining of the integrated multi-dimensional data based on the first multi-dimensional data and the second multi-dimensional data may include obtaining common contour data included in the integrated multi-dimensional data based on the first multi-dimensional data and the second multi-dimensional data, and the predicting of the volume of the object based on the integrated multi-dimensional data may include obtaining first filtered integrated multi-dimensional data by filtering the integrated multi-dimensional data based on the common contour data; and predicting the volume of the object based on the first filtered integrated multi-dimensional data.

Alternatively, the predicting of the volume of the object based on the integrated multi-dimensional data may include identifying a non-correspondence area between the first multi-dimensional data and the second multi-dimensional data included in the integrated multi-dimensional data; obtaining second filtered integrated multi-dimensional data by filtering the non-correspondence area for the integrated multi-dimensional data; and predicting the volume of the object based on the second filtered integrated multi-dimensional data.

Alternatively, the obtaining of the second filtered integrated multi-dimensional data by filtering the non-correspondence area for the integrated multi-dimensional data may include identifying a correspondence area to the first multi-dimensional data based on the second multi-dimensional data included in the integrated multi-dimensional data; and obtaining the second filtered integrated multi-dimensional data by filtering the non-correspondence area other than the identified correspondence area for the second multi-dimensional data included in the integrated multi-dimensional data.

Another exemplary embodiment of the present disclosure provides a computer program stored in a non-transitory computer readable medium. The computer program may cause one or more processors to perform operations for predicting a volume of an object when the computer program is executed by the one or more processors, and the operations may include: an operation of obtaining a first-time image and a second-time image including a container capable of containing an object; an operation of identifying a second object area for the second-time image and identifying a first object area for the first-time image; an operation of obtaining first multi-dimensional data based on the first object area included in the first-time image and obtaining second multi-dimensional data based on the second object area included in the second-time image; and an operation of the volume of the object based on the first multi-dimensional data and the second multi-dimensional data.

Alternatively, the operation of identifying the second object area for the second-time image and identifying the first object area for the first-time image may include an operation of identifying a second container area included in the second-time image and identifying a second object area inside the second container area; and an operation of identifying a first container area included in the first-time image, which corresponds to the second container area, and identifying a first object area inside the first container area.

Alternatively, the operation of identifying the second object area for the second-time image and identifying the first object area for the first-time image may include an operation of identifying the first object area for the first-time image based on the second object area.

Alternatively, the operation of obtaining the first multi-dimensional data based on the first object area included in the first-time image and obtaining the second multi-dimensional data based on the second object area included in the second-time image may include an operation of obtaining first point cloud data based on the first object area, and obtaining second point cloud data based on the second object area; and an operation of obtaining the first multi-dimensional data based on the obtained first point cloud data and obtaining the second multi-dimensional data based on the second point cloud data.

Alternatively, the operation of obtaining the first multi-dimensional data based on the obtained first point cloud data and obtaining the second multi-dimensional data based on the second point cloud data may include an operation of obtaining the first multi-dimensional data and the second multi-dimensional data by correcting each of empty spaces included in the first point cloud data and the second point cloud data.

Alternatively, the operation of the volume of the object based on the first multi-dimensional data and the second multi-dimensional data may include an operation of obtaining integrated multi-dimensional data based on the first multi-dimensional data and the second multi-dimensional data; and an operation of predicting the volume of the object based on the integrated multi-dimensional data.

Alternatively, the operation of obtaining the integrated multi-dimensional data based on the first multi-dimensional data and the second multi-dimensional data may include an operation of obtaining common contour data included in the integrated multi-dimensional data based on the first multi-dimensional data and the second multi-dimensional data, and the operation of predicting the volume of the object based on the integrated multi-dimensional data may include an operation of obtaining first filtered integrated multi-dimensional data by filtering the integrated multi-dimensional data based on the common contour data; and an operation of predicting the volume of the object based on the first filtered integrated multi-dimensional data.

Alternatively, the operation of predicting the volume of the object based on the integrated multi-dimensional data may include an operation of identifying a non-correspondence area between the first multi-dimensional data and the second multi-dimensional data included in the integrated multi-dimensional data; an operation of obtaining second filtered integrated multi-dimensional data by filtering the non-correspondence area for the integrated multi-dimensional data; and an operation of predicting the volume of the object based on the second filtered integrated multi-dimensional data.

Yet another exemplary embodiment of the present disclosure provides a computing device. The device may include: at least one processor; and a memory, and the at least one processor may be configured to obtain a first-time image and a second-time image including a container capable of containing an object; identify a second object area for the second-time image and identifying a first object area for the first-time image; obtain first multi-dimensional data based on the first object area included in the first-time image and obtain second multi-dimensional data based on the second object area included in the second-time image; and predict the volume of the object based on the first multi-dimensional data and the second multi-dimensional data.

Still yet another exemplary embodiment of the present disclosure provides a data structure included in a computer-readable storage medium. The data structure may correspond to a parameter of a neural network, and the neural network may perform the following steps at least partially based on the parameter, and the steps may include obtaining a first-time image and a second-time image including a container capable of containing an object; identifying a second object area for the second-time image and identifying a first object area for the first-time image; obtaining first multi-dimensional data based on the first object area included in the first-time image and obtaining second multi-dimensional data based on the second object area included in the second-time image; and predicting a volume of the object based on the first multi-dimensional data and the second multi-dimensional data.

According to an exemplary embodiment of the present disclosure, provided is a method for predicting a volume of an object, and more particularly, it is possible to obtain data before and after a change of an object by using multi-dimensional data of a container containing an object, and predict a volume of the object based on the obtained data.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

FIG. 1 is a block diagram of a computing device for predicting a volume of an object according to an exemplary embodiment of the present disclosure.

FIG. 2 is a schematic diagram illustrating a network function according to an exemplary embodiment of the present disclosure.

FIG. 3 is a flowchart illustrating a method for predicting a volume of an object according to an exemplary embodiment of the present disclosure.

FIG. 4 is a schematic view for describing a process of obtaining a first-time image and a second-time image including a container capable of containing an object, and identifying first and second object areas for the first and second-time images, respectively according to an exemplary embodiment of the present disclosure.

FIG. 5 is a schematic view for describing a process of obtaining first multi-dimensional data and second multi-dimensional data according to an exemplary embodiment of the present disclosure.

FIG. 6 is a schematic view for describing a process of obtaining integrated multi-dimensional data based on first multi-dimensional data and second multi-dimensional data according to an exemplary embodiment of the present disclosure.

FIGS. 7A to 7C are schematic views for describing a process of predicting the volume of the object based on first multi-dimensional data and second multi-dimensional data according to an exemplary embodiment of the present disclosure.

FIG. 8 is a simple and normal schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.
It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.
The term “at least one of A or B” should be interpreted to mean “a case including only A”, “a case including only B”, and “a case in which A and B are combined”.
Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

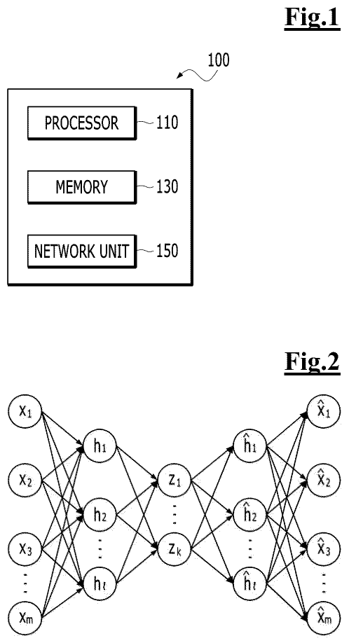

FIG. 1 is a block diagram of a computing device for predicting a volume of an object according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

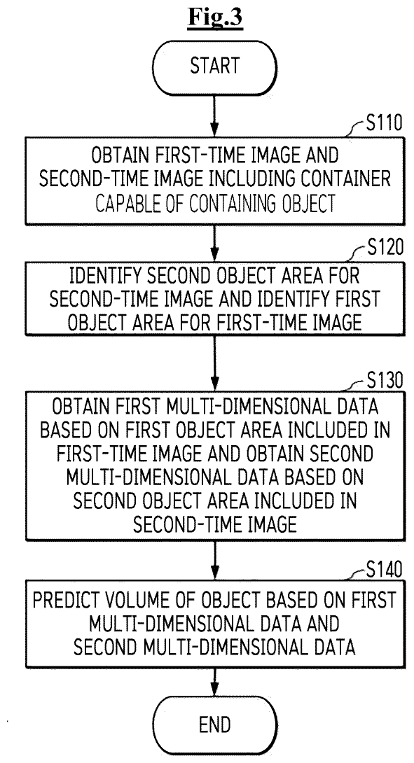

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

FIG. 3 is a flowchart illustrating a method for predicting a volume of an object according to an exemplary embodiment of the present disclosure.

A computing device 100 according to an exemplary embodiment of the present disclosure may directly obtain “information for predicting a volume of an object” or receive the “information for predicting the volume of the object” from an external system. The external system may be a server or database that stores and manages the information for predicting the volume of the object. The computing device 100 may use the information obtained directly or received from the external system as “input data for predicting the volume of the object”.

According to an exemplary embodiment of the present disclosure, the computing device 100 may obtain a first-time image and a second-time image including a container capable of containing an object (S110). At this time, the first time or the second time may mean information which may distinguish images by using a temporal difference, and for example, the first-time or second-time images may be distinguished into a T1-time image, a T2-time image, etc. For example, the computing device 100 may obtain the first-time and second-time images including the container using a depth camera, and the first-time or second-time image may include an RGBD image. In this case, the depth camera may mean a camera that measures distance information to a specific point of an environment or an object, and the depth camera may include, for example, a camera which measures a depth value of each pixel in a 2D image to secure 3D information of a space. On the other hand, the images may be obtained through various technologies such as laser scanning, structural light scanning, a time-of-flight camera, a stereo vision system, photogrammetry, etc., in addition to a scheme of using the depth camera, and are not limited to an example such as the depth camera, etc.

According to an exemplary embodiment of the present disclosure, the computing device 100 may identify a second object area for the second-time image obtained through step S110, and identify a first object area for the first-time image (S120). Specifically, the computing device 100 may identify a second container area included in the second-time image, and identify a second object area inside the second container area. Further, the computing device 100 may identify a first container area included in the first-time image, which corresponds to the second container area, and identify a first object area inside the first container area. At this time, the computing device 100 identifies the first or second container area, and identifies the object area inside each container area based on the identified first or second container area to increase an identification accuracy of the object area.

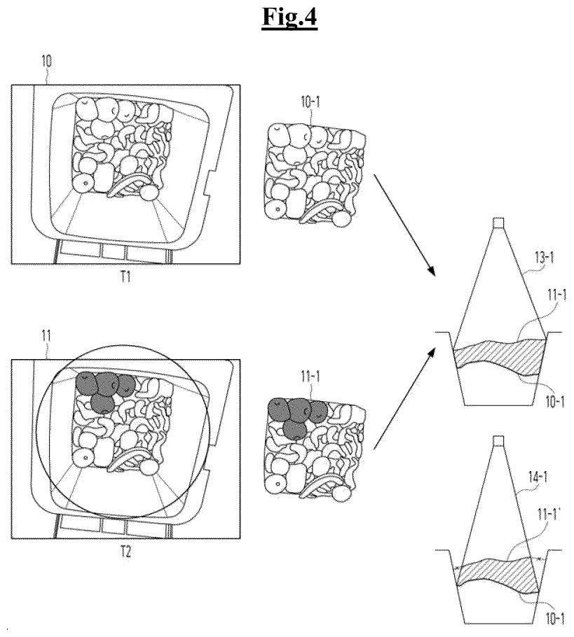

Meanwhile, according to an exemplary embodiment of the present disclosure, the computing device 100 may identify the first object area for the first-time image based on the second object area. In this regard, when food waste is loaded in a container with a specified specification, the container may be generally configured in a cylindrical or a trapezoidal cylindrical form. At this time, each of the first or second object area may be identified by using a pre-trained object division neural network model such as U-Net, fully convolutional network (FCN), mask R-CNN, etc., but the present disclosure is not limited thereto. Meanwhile, in general, an area of the first object area which is an object area before the food waste is loaded in the container is smaller than the second object area which is an object area after the food waste is loaded in the container. Accordingly, when the computing device 100 identifies the second object area for the second-time image based on the first object area, the area of the first object area is smaller than the area of the second object area, so an area which is not recognized in the second object area may be included. Accordingly, the computing device 100 identifies the first object area for the first-time image based on the second object area to use the first object area in a process of identifying a more accurate object area and predicting a volume of an object to be described below, and a detailed description thereof is made through FIG. 4 below.

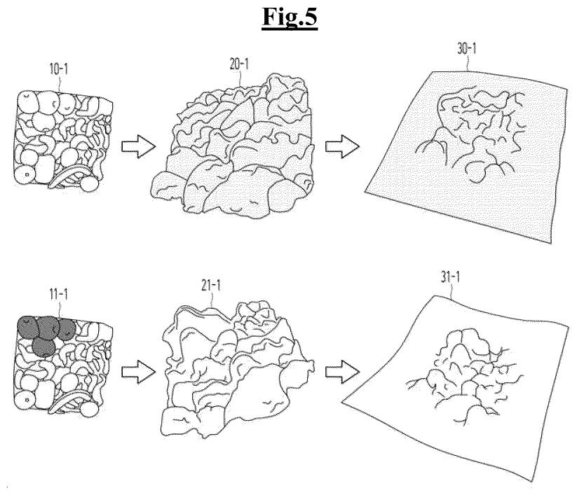

According to an exemplary embodiment of the present disclosure, the computing device 100 may identify first multi-dimensional data based on the first object area identified through step S120, and obtain second multi-dimensional data based on the second object area (S130). At this time, the multi-dimensional data may include multi-dimensional mesh data, but is not limited thereto. Specifically, the computing device 100 may obtain first point cloud data based on the first object area, and obtain second point cloud data based on the second object area. For example, since a depth image includes one distance value per pixel when the first-time image is the RGBD image, the computing device 100 converts the first-time image into X, Y, and Z coordinates to obtain the first point cloud data, and the computing device 1100 may obtain the second point cloud data by performing the same process even for the second-time image. Further, the computing device 100 may obtain the first multi-dimensional data and the second multi-dimensional data by correcting each of empty spaces included in the first point cloud data and the second point cloud data. In this regard, the computing device 100 may correct the empty space included in the first point cloud data based on at least one of an interpolation method of generating a new point and correcting an empty space by analyzing characteristics of a surrounding data point, a reconstruction method of using a geometric model of filling the empty space by analyzing geometric characteristics of the surrounding data point or a statistical model of predicting a missed area based on a distribution of data points, or a filtering method of removing noise or refining data before or after correcting the empty space. Similarly, the above-described examples may be used even for the second point cloud data, and as an example of the interpolation method, a linear interpolation, a triangular interpolation, a spline interpolation, etc., may be used, and as an example of the filtering method, a movement average filter, a high-frequency filter, a robust filter, etc., may be used, but the present disclosure is not limited thereto. Additionally, the computing device 100 connects point data in a triangular shape or polygonal shape based on neighboring point data for each of the corrected first cloud data or corrected second cloud data to obtain multi-dimensional mesh data, and obtain the first or second multi-dimensional data through the obtained multi-dimensional mesh data. Meanwhile, a specific description of a process of obtaining the obtained first or second multi-dimensional data is made through FIG. 5 below.

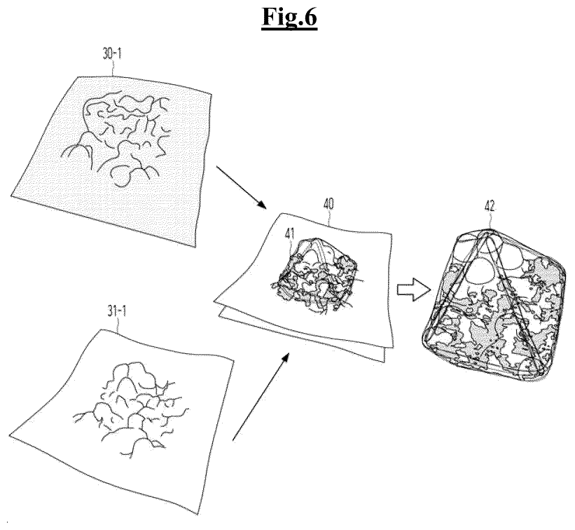

According to an exemplary embodiment of the present disclosure, the computing device 100 may predict the volume of the object based on the first multi-dimensional data and the second multi-dimensional data obtained through step S130 (S140). Specifically, the computing device 100 may obtain integrated multi-dimensional data based on the first multi-dimensional data and the second multi-dimensional data, and predict the volume of the object based on the integrated multi-dimensional data. In this regard, the computing device 100 may use a difference between second multi-dimensional data at the second time and first multi-dimensional data at the first time in order to predict the volume of the object, and in order to accurately calculate the difference, the computing device 100 aligns the first multi-dimensional data and the second multi-dimensional data to obtain the integrated multi-dimensional data. For example, the computing device 100 obtains common contour data included in the integrated multi-dimensional data based on the first multi-dimensional data and the second multi-dimensional data, and filters the integrated multi-dimensional data based on the common contour data to obtain first filtered integrated multi-dimensional data. At this time, the common contour data may mean a contour of an area required for predicting the volume of the object in the first multi-dimensional data and the second multi-dimensional data among the integrated multi-dimensional data, and the computing device 100 may obtain the first filtered integrated multi-dimensional data from which an area not required for predicting the volume of the object is removed by filtering the integrated multi-dimensional data based on the common contour data. Thereafter, the computing device 100 reduces an error by removing the area not required for predicting the volume of the object by predicting the volume of the object based on the first filtered integrated multi-dimensional data, thereby more accurately predicting the volume of the object. In this regard, a specific description of a process of obtaining the first filtered integrated multi-dimensional data is described below through FIG. 6 below.

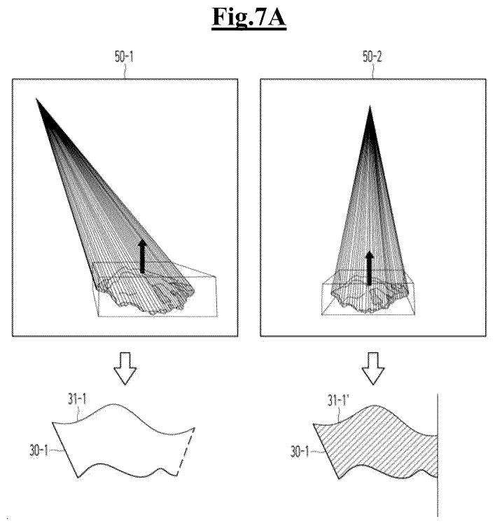

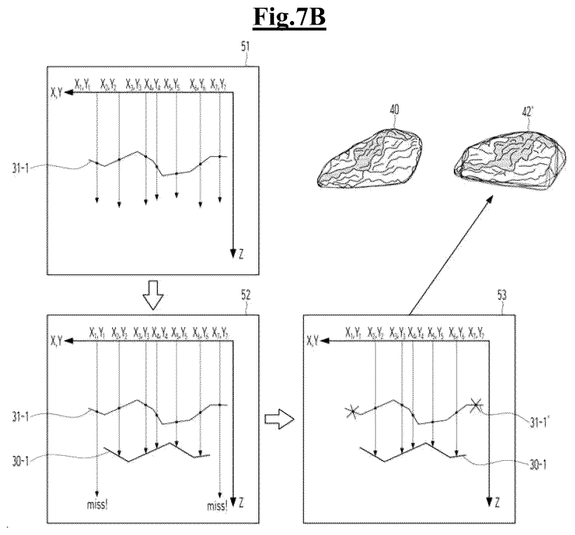

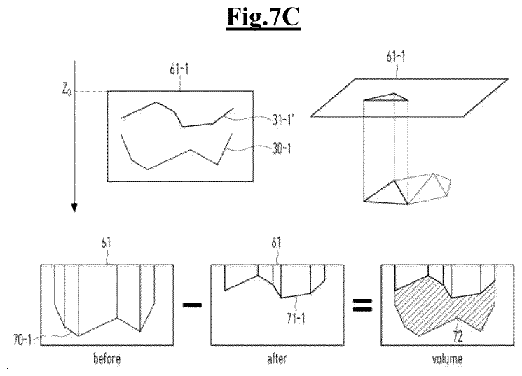

Meanwhile, even though the computing device 100 obtains the integrated multi-dimensional data by aligning the first multi-dimensional data and the second multi-dimensional data, a location of the container may be finely changed, or a case where the first multi-dimensional data and the second multi-dimensional data do not correspond to each other may occur due to a missing value. Accordingly, according to an exemplary embodiment of the present disclosure, the computing device 100 identifies a non-correspondence area between the first multi-dimensional data and the second multi-dimensional data included in the integrated multi-dimensional data, and filters the non-correspondence area for the integrated multi-dimensional data to obtain second filtered integrated multi-dimensional data, and predict the volume of the object based on the second filtered integrated multi-dimensional data. Specifically, the computing device 100 identifies a correspondence area to the first multi-dimensional data based on the second multi-dimensional data included in the integrated multi-dimensional data, and filters the non-correspondence area other than the identified correspondence area for the second multi-dimensional data included in the integrated multi-dimensional data to obtain the second filtered integrated multi-dimensional data. For example, the computing device 100 may obtain a rotation matrix of first and second multi-dimensional mesh data by using an oriented box included in the integrated multi-dimensional data, and obtain integrated multi-dimensional data rotated in an origin direction by multiplying the integrated multi-dimensional data by a transposed matrix for the rotation matrix. Thereafter, the computing device 100 may obtain a list including midpoint x and y coordinates for each of second meshes included in the second multi-dimensional data, and connect virtual rays with (x, y, 0)s as an origin in a z-axis direction. At this time, when the virtual rays pass through first meshes included in the first multi-dimensional data together, the computing device 100 may identify an area among the virtual rays, which passes through the first meshes simultaneously as the correspondence area, and identify an area among the virtual rays which does not pass through the first meshes included in the first multi-dimensional data, other than the correspondence area, as the non-correspondence area. Thereafter, the computing device 100 filters the non-correspondence area for the integrated multi-dimensional data to obtain the second filtered integrated multi-dimensional data, and predict the volume of the object based on the obtained second filtered integrated multi-dimensional data. Through this, the computing device 100 may reduce the error for predicting the volume of the object even when the location of the container is finely changed or the first multi-dimensional data and the second multi-dimensional data do not correspond to each other due to the missing value. Meanwhile, a specific description for a process in which the computing device 100 predicts the volume of the object based on the first and second multi-dimensional data is made below through FIGS. 7A to 7C below.

FIG. 4 is a schematic view for describing a process of obtaining a first-time image and a second-time image including a container capable of containing an object, and identifying first and second object areas for the first and second-time images, respectively according to an exemplary embodiment of the present disclosure.

Referring to FIG. 4, the computing device 100 may obtain a first-time image 10 and a second-time image 11 including a container capable of containing an object. At this time, T1 which is the first time and T2 which is the second time may mean information which may distinguish images by using a temporal difference, and the T2 time may be a time after the T1 time. For example, the computing device 100 may obtain the first-time image 10 and the second-time image 11 including the container using the depth camera, and the first-time or second-time image 10 or 11 may include the RGBD image. In this case, the depth camera may mean a camera that measures distance information to a specific point of an environment or an object, and the depth camera may include, for example, a camera which measures a depth value of each pixel in a 2D image to secure 3D information of a space. On the other hand, the images 10 or 11 may be obtained through various technologies such as laser scanning, structural light scanning, a time-of-flight camera, a stereo vision system, photogrammetry, etc., in addition to a scheme of using the depth camera, and are not limited to an example such as the depth camera, etc.

Further, the computing device 100 may identify a second object area 11-1 for the second-time image 11 and identify a first object area 10-1 for the first-time image 10. Specifically, the computing device 100 may identify a second container area included in the second-time image 11 and identify the second object area 11-1 inside the second container area. Further, the computing device 100 may identify a first container area included in the first-time image 10, which corresponds to the second container area, and identify the first object area 10-1 inside the first container area. At this time, the computing device 100 identifies the first or second container area, and identifies the object area 10-1 or 11-1 inside each container area based on the identified first or second container area to increase an identification accuracy of the object area.

Meanwhile, the computing device 100 may identify the first object area 10-1 for the first-time image based on the second object area 11-1. In this regard, when food waste is loaded in a container with a specified specification, the container may be generally configured in a cylindrical or a trapezoidal cylindrical form. At this time, each of the first or second object area 10-1 or 11-1 may be identified by using a pre-trained neural network model which may recognize and segment an object, such as U-Net, FCN (Fully Convolutional Network), Mask R-CNN, etc., but is not limited to the example. In this regard, in general, an area of the first object area 10-1 which is an object area before the food waste is loaded in the container is smaller than the second object area 11-1 which is an object area after the food waste is loaded in the container. For example, the second object area 11-1 may be larger than the first object area 10-1 by an area in which four gray apples are added. Accordingly, as in an example 14-1 of FIG. 4, when the computing device 100 identifies a second' object area 11-1′ for the second-time image 11 based on the first object area 10-1, an area of a first object area 10-1′ is smaller than an area of a second′ object area 11-1′, so an area which is not recognized in the second′ object area 11-1′ may be included. Unlike, as in an example 13-1 of FIG. 4, when the computing device 100 identifies the first object area 10-1 for the first-time image 10 based on the second object area 11-1, an area of the second object area 11-1 is larger than an area of the first object area 10-1, so a possibility that an area which is not recognized in the first object area 10-1 will be generated is relatively low. Accordingly, as in the example 13-1 of FIG. 4, the computing device 100 identifies the first object area 10-1 for the first-time image 10 based on the second object area 11-1 to identify a more accurate object area and use the identified object area in a process of predicting a volume of an object to be described below.

FIG. 5 is a schematic view for describing a process of obtaining first multi-dimensional data and second multi-dimensional data according to an exemplary embodiment of the present disclosure.

Referring to FIG. 5, the computing device 100 may obtain first multi-dimensional data 30-1 based on the identified first object area 10-1 and obtain second multi-dimensional data 31-1 based on the second object area 11-1. At this time, the multi-dimensional data 30-1 or 31-1 may include multi-dimensional mesh data, but is not limited thereto. Specifically, the computing device 100 may obtain first point cloud data 20-1 based on the first object area 10-1, and obtain second point cloud data 21-1 based on the second object area 11-1. For example, since a depth image includes one distance value per pixel when the first-time image 10 is the RGBD image, the computing device 100 converts the first-time image 10 into X, Y, and Z coordinates to obtain the first point cloud data 20-1, and obtain the second point cloud data 21-1 by performing the same process even for the second-time image 11. Specifically, the computing device 100 may obtain the first and second point cloud data 20-1 and 21-1 through a method which leaves only a point cloud cluster of a largest cluster by using a DBSCAN scheme clustering method except for a part (missing value) in which a depth data value is 0 for the first and second-time images 10 and 11. Further, the computing device 100 may obtain the first multi-dimensional data 30-1 and the second multi-dimensional data 31-1 by correcting each of empty spaces included in the first point cloud data 20-1 and the second point cloud data 21-1. In this regard, the computing device 100 may correct the empty space included in the first point cloud data 20-1 based on at least one of an interpolation method of generating a new point and correcting an empty space by analyzing characteristics of a surrounding data point, a reconstruction method of using a geometric model of filling the empty space by analyzing geometric characteristics of the surrounding data point or a statistical model of predicting a missed area based on a distribution of data points, or a filtering method of removing noise or refining data before or after correcting the empty space. Similarly, the above-described examples may be used even for the second point cloud data 21-1, and as an example of the interpolation method, a linear interpolation, a triangular interpolation, a spline interpolation, etc., may be used, and as an example of the filtering method, a movement average filter, a high-frequency filter, a robust filter, etc., may be used, but the present disclosure is not limited thereto. Additionally, the computing device 100 connects point data in a triangular shape or polygonal shape based on neighboring point data for each of the corrected first cloud data or corrected second cloud data to obtain multi-dimensional mesh data, and obtain the first or second multi-dimensional data through the obtained multi-dimensional mesh data. For example, the computing device 100 may obtain first multi-dimensional data 30-1 which is multi-dimensional mesh data by using a Poisson reconstruction algorithm for the first point cloud data 20-1, and also obtain second multi-dimensional data 31-1 by using the same method for the second point cloud data 21-1. However, a process of obtaining the first or second multi-dimensional data 30-1 or 31-1 is not limited to an example, and various examples may be used. Meanwhile, the computing device 100 may obtain the integrated multi-dimensional data based on the obtained first or second multi-dimensional data 30-1 or 31-1 in order to predict the volume of the object, and a specific description thereof is made below through FIG. 6 below.

FIG. 6 is a schematic view for describing a process of obtaining integrated multi-dimensional data based on first multi-dimensional data and second multi-dimensional data according to an exemplary embodiment of the present disclosure.

Referring to FIG. 6, the computing device 100 may obtain integrated multi-dimensional data 40 based on the first multi-dimensional data 30-1 and the second multi-dimensional data 31-1, and predict the volume of the object based on the integrated multi-dimensional data 40. In this regard, the computing device 100 may use a difference between the second multi-dimensional data 31-1 at the second time and the first multi-dimensional data 30-1 at the first time in order to predict the volume of the object, and in order to accurately calculate the difference, the computing device 100 aligns the first multi-dimensional data 30-1 and the second multi-dimensional data 31-1 to obtain the integrated multi-dimensional data 40. However, the first multi-dimensional data 30-1 and the second multi-dimensional data 31-1 are obtained through the Poisson reconstruction algorithm, and a multi-dimensional mesh may be extended up to an area not required for predicting the volume of the object, and the integrated multi-dimensional data 40 may also be in a state in which the multi-dimensional mesh is extended up to the area not required in the process of predicting the volume of the object. Accordingly, the computing device 100 obtains common contour data 41 included in the integrated multi-dimensional data 40 based on the first multi-dimensional data 30-1 and the second multi-dimensional data 31-1, and filters the integrated multi-dimensional data based 40 on the common contour data 41 to obtain first filtered integrated multi-dimensional data 42. At this time, the common contour data 41 may mean a contour of the area required for predicting the volume of the object in the first multi-dimensional data 30-1 and the second multi-dimensional data 31-1 among the integrated multi-dimensional data 40, and for example, a convex hull of the point cloud data may be included, but the present disclosure is not limited thereto. Further, the computing device 100 may obtain the first filtered integrated multi-dimensional data 42 in which the area not required for predicting the volume of the object is removed by filtering the integrated multi-dimensional data 40 based on the common contour data 41. Thereafter, the computing device 100 removes the area not required for predicting the volume of the object by predicting the volume of the object based on the first filtered integrated multi-dimensional data 42 to reduce an error of a calculation process and more accurately predict the volume of the object. Meanwhile, a specific description for the process of predicting the volume of the object by the computing device 100 will be made below through FIG. 7C below.

FIGS. 7A to 7C are schematic views for describing a process of predicting the volume of the object based on first multi-dimensional data and second multi-dimensional data according to an exemplary embodiment of the present disclosure.

According to an exemplary embodiment of the present disclosure, even though the computing device 100 obtains the integrated multi-dimensional data 40 by aligning the first multi-dimensional data 30-1 and the second multi-dimensional data 31-1, a location of the container may be finely changed, or a case where the first multi-dimensional data 30-1 and the second multi-dimensional data 31-1 do not correspond to each other may occur due to a missing value.

Referring to an example 50-1 of FIG. 7A, the first-time image 10 and the second-time image 11 may be images captured in a top left diagonal line other than images captured by the depth camera just above the container capable of containing an object. At this time, a boundary of a left side surface in the integrated multi-dimensional data 40 obtained based on the second object area 31-1 and the first object area 30-1 may be aligned, but a right dotted-line boundary may be identified as the non-correspondence area. Accordingly, only when the computing device 100 filters the identified non-correspondence area for the integrated multi-dimensional data 40, the computing device 100 may reduce an error in predicting the volume. For example, referring to an example 50-2 of FIG. 7A, the computing device 100 may obtain a rotation matrix of first and second multi-dimensional mesh data 30-1 and 31-1 by using an oriented box included in the integrated multi-dimensional data 40, and obtain integrated multi-dimensional data rotated in an origin direction by multiplying the integrated multi-dimensional data 40 by a transposed matrix for the rotation matrix.

Thereafter, referring to FIG. 7B, the computing device 100 may obtain a list including midpoint x and y coordinates for each of the second meshes included in the second multi-dimensional data 31-1, and connect virtual rays with (x, y, 0) s as an origin in a z-axis direction. For example, as in example 51 of FIG. 7B, the computing device 100 may connect virtual rays with coordinates of (x1, y1, 0) to (x7, y7, 0) as an origin to the second multi-dimensional data 31-1 in the z-axis direction. At this time, when the virtual rays pass through first meshes included in the first multi-dimensional data 30-1 together, the computing device 100 may identify an area among the virtual rays, which passes through the first multi-dimensional data 30-1 and the second multi-dimensional data 31-1 simultaneously as the correspondence area, and identify an area among the virtual rays which passes through the second meshes included in the second multi-dimensional data 31-1, but does not pass through the first meshes included in the first multi-dimensional data 30-1, other than the correspondence area, as the non-correspondence area. Specifically, as in example 52 of FIG. 7B, the computing device 100 may identify an area among the virtual rays with the coordinates of (x1, y1, 0) to (x7, y7, 0) as the origin, which correspond to coordinates of (x2, y2, z) to (x6, y6, z) which passes the first multi-dimensional data 30-1 and the second multi-dimensional data 31-1 as the correspondence area, and identify an area corresponding to coordinates of (x1, y1, z) and (x7, y7, z) as the non-correspondence area.

Thereafter, the computing device 100 filters the non-correspondence area for the integrated multi-dimensional data 40 to obtain the second filtered integrated multi-dimensional data 42′. Specifically, as in example 52 of FIG. 7B, the computing device 100 filters the non-correspondence area corresponding to the coordinates of (x1, y1, z) and (x7, y7, z) to obtain second filtered multi-dimensional data 31-1′, and obtain the second filtered integrated multi-dimensional data 42′ based on the second filtered multi-dimensional data 31-1′ and the first multi-dimensional data 30-1. Through this, the computing device 100 may reduce the error for predicting the volume of the object even when the location of the container is finely changed or the first multi-dimensional data 30-1 and the second multi-dimensional data 31-1 do not correspond to each other due to the missing value.

Referring to FIG. 7C, the computing device 100 may predict the volume of the object based on the integrated multi-dimensional data 40. For example, the computing device 100 may set an oriented box 61 including the integrated multi-dimensional data 40. Thereafter, the computing device 100 projects a first-1 mesh included in the first multi-dimensional data 30-1 with respect to a top surface 61-1 of the oriented box 61 to obtain a 1-first polygonal column in which a bottom surface is the 1-first multi-dimensional mesh and a top surface is a first-1 multi-dimensional mesh projected to the oriented box 61, and obtain a volume for the first-1 polygonal column. By repeating such a process, the computing device 100 aggregates all volumes of the first-1 polygonal column to a first-n polygonal column included in the first multi-dimensional data 30-1 to obtain a first approximation volume 70-1. Further, by performing such a process even for the second filtered multi-dimensional data 31-1′ similarly, the computing device 100 aggregates all volumes of a second-1 polygonal column to a second-n polygonal column included in the second filtered multi-dimensional data 31-1′ to obtain a second approximation volume 71-1. Thereafter, the computing device 100 may predict the volume of the object 72 through a difference between the first approximation volume 70-1 and the second approximation volume 71-1. Through this, the computing device 100 may reduce a calculation time by using the first and second approximation volumes 70-1 and 71-1 in the process of predicting the volume of the object, thereby effectively predicting the volume of the object, which is changed in real time. Further, the computing device 100 removes the area not required for predicting the volume of the object through the above-described exemplary embodiment of the present disclosure to reduce the error in the calculation process and more accurately predict the volume of the object.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availablely designed data structure, a computing device can perform operations while using the resources of the computing device to a minimum. Specifically, the computing device can increase the efficiency of operation, read, insert, delete, compare, exchange, and search through the availablely designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO—Last in First Out) in which the data is input last and output first. The queue is a data listing structure that may access data limitedly and unlike a stack, the queue may be a data structure (FIFO—First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

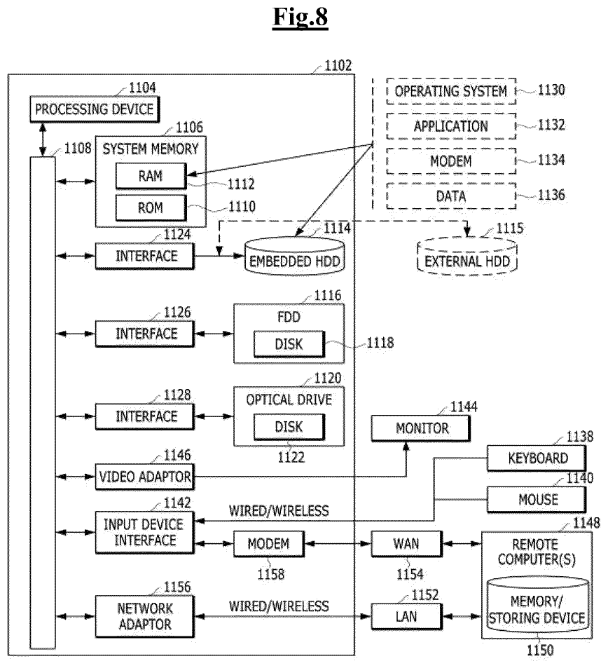

FIG. 8 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.
The computer readable transmission media generally implement the computer readable command, the data structure, the program module, or other data in a carrier wave or a modulated data signal such as other transport mechanism and include all information transfer media. The term “modulated data signal” means a signal obtained by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for predicting a volume of an object, the method performed by one or more processors of a computing device, the method comprising:
obtaining a first-time image and a second-time image including a container capable of containing an object;
identifying a second object area for the second-time image and identifying a first object area for the first-time image;
obtaining first multi-dimensional data based on the first object area included in the first-time image and obtaining second multi-dimensional data based on the second object area included in the second-time image; and
predicting a volume of the object based on the first multi-dimensional data and the second multi-dimensional data.

2. The method of claim 1, wherein the identifying of the second object area for the second-time image and identifying the first object area for the first-time image includes:
identifying a second container area included in the second-time image and identifying a second object area inside the second container area; and
identifying a first container area included in the first-time image, which corresponds to the second container area, and identifying a first object area inside the first container area.

3. The method of claim 1, wherein the identifying of the second object area for the second-time image and identifying the first object area for the first-time image includes:
identifying the first object area for the first-time image based on the second object area.

4. The method of claim 1, wherein the multi-dimensional data includes multi-dimensional mesh data.

5. The method of claim 1, wherein the obtaining of the first multi-dimensional data based on the first object area included in the first-time image and obtaining the second multi-dimensional data based on the second object area included in the second-time image includes:
obtaining first point cloud data based on the first object area, and obtaining second point cloud data based on the second object area; and
obtaining the first multi-dimensional data based on the obtained first point cloud data and obtaining the second multi-dimensional data based on the second point cloud data.

6. The method of claim 5, wherein the obtaining of the first multi-dimensional data based on the obtained first point cloud data and obtaining the second multi-dimensional data based on the second point cloud data includes
obtaining the first multi-dimensional data and the second multi-dimensional data by correcting each of empty spaces included in the first point cloud data and the second point cloud data.

7. The method of claim 6, wherein a process of correcting each of the empty spaces included in the first point cloud data and the second point cloud data is performed based on at least one of:
an interpolation method;
a reconstruction method; or
a filtering method.

8. The method of claim 1, wherein the predicting of the volume of the object based on the first multi-dimensional data and the second multi-dimensional data includes:
obtaining integrated multi-dimensional data based on the first multi-dimensional data and the second multi-dimensional data; and
predicting the volume of the object based on the integrated multi-dimensional data.

9. The method of claim 8, wherein the obtaining of the integrated multi-dimensional data based on the first multi-dimensional data and the second multi-dimensional data includes:
obtaining common contour data included in the integrated multi-dimensional data based on the first multi-dimensional data and the second multi-dimensional data; and
wherein the predicting of the volume of the object based on the integrated multi-dimensional data includes:
obtaining first filtered integrated multi-dimensional data by filtering the integrated multi-dimensional data based on the common contour data; and
predicting the volume of the object based on the first filtered integrated multi-dimensional data.

10. The method of claim 8, wherein the predicting of the volume of the object based on the integrated multi-dimensional data includes:
identifying a non-correspondence area between the first multi-dimensional data and the second multi-dimensional data included in the integrated multi-dimensional data;
obtaining second filtered integrated multi-dimensional data by filtering the non-correspondence area for the integrated multi-dimensional data; and
predicting the volume of the object based on the second filtered integrated multi-dimensional data.

11. The method of claim 10, wherein the obtaining of the second filtered integrated multi-dimensional data by filtering the non-correspondence area for the integrated multi-dimensional data includes:
identifying a correspondence area to the first multi-dimensional data based on the second multi-dimensional data included in the integrated multi-dimensional data; and
obtaining the second filtered integrated multi-dimensional data by filtering the non-correspondence area other than the identified correspondence area for the second multi-dimensional data included in the integrated multi-dimensional data.

12. A computer program stored in a non-transitory computer-readable storage medium, wherein the computer program causes one or more processors to perform operations for predicting a volume of an object when the computer program is executed by the one or more processors, the operations comprising:
an operation of obtaining a first-time image and a second-time image including a container capable of containing an object;
an operation of identifying a second object area for the second-time image and identifying a first object area for the first-time image;
an operation of obtaining first multi-dimensional data based on the first object area included in the first-time image and obtaining second multi-dimensional data based on the second object area included in the second-time image; and
an operation of predicting a volume of the object based on the first multi-dimensional data and the second multi-dimensional data.

13. The computer program of claim 12, wherein the operation of identifying the second object area for the second-time image and identifying the first object area for the first-time image includes:
an operation of identifying a second container area included in the second-time image and identifying a second object area inside the second container area; and
an operation of identifying a first container area included in the first-time image, which corresponds to the second container area, and identifying a first object area inside the first container area.

14. The computer program of claim 12, wherein the operation of identifying the second object area for the second-time image and identifying the first object area for the first-time image includes:
an operation of identifying the first object area for the first-time image based on the second object area.

15. The computer program of claim 12, wherein the operation of obtaining the first multi-dimensional data based on the first object area included in the first-time image and obtaining the second multi-dimensional data based on the second object area included in the second-time image includes:
an operation of obtaining first point cloud data based on the first object area, and obtaining second point cloud data based on the second object area; and
an operation of obtaining the first multi-dimensional data based on the obtained first point cloud data and obtaining the second multi-dimensional data based on the second point cloud data.

16. The computer program of claim 15, wherein the operation of obtaining the first multi-dimensional data based on the obtained first point cloud data and obtaining the second multi-dimensional data based on the second point cloud data includes:
an operation of obtaining the first multi-dimensional data and the second multi-dimensional data by correcting each of empty spaces included in the first point cloud data and the second point cloud data.

17. The computer program of claim 12, wherein the operation of the volume of the object based on the first multi-dimensional data and the second multi-dimensional data includes:
an operation of obtaining integrated multi-dimensional data based on the first multi-dimensional data and the second multi-dimensional data; and
an operation of predicting the volume of the object based on the integrated multi-dimensional data.

18. The computer program of claim 17, wherein the operation of obtaining the integrated multi-dimensional data based on the first multi-dimensional data and the second multi-dimensional data includes:
an operation of obtaining common contour data included in the integrated multi-dimensional data based on the first multi-dimensional data and the second multi-dimensional data; and
wherein the operation of predicting the volume of the object based on the integrated multi-dimensional data includes:
an operation of obtaining first filtered integrated multi-dimensional data by filtering the integrated multi-dimensional data based on the common contour data; and
an operation of predicting the volume of the object based on the first filtered integrated multi-dimensional data.

19. The computer program of claim 17, wherein the operation of predicting the volume of the object based on the integrated multi-dimensional data includes:
an operation of identifying a non-correspondence area between the first multi-dimensional data and the second multi-dimensional data included in the integrated multi-dimensional data;
an operation of obtaining second filtered integrated multi-dimensional data by filtering the non-correspondence area for the integrated multi-dimensional data; and
an operation of predicting the volume of the object based on the second filtered integrated multi-dimensional data.

20. A computing device comprising:
at least one processor; and
a memory,
wherein the at least one processor is configured to:
obtain a first-time image and a second-time image including a container capable of containing an object;
identify a second object area for the second-time image and identifying a first object area for the first-time image;
obtain first multi-dimensional data based on the first object area included in the first-time image and obtain second multi-dimensional data based on the second object area included in the second-time image; and
predict a volume of the object based on the first multi-dimensional data and the second multi-dimensional data.
